(19) United States
(12) Patent Application Publication
(10) Pub. No.: US 2013/0282455 A1
(43) Pub. Date: Oct. 24, 2013

(54) METHOD, SYSTEM, AND COMPUTER PROGRAM FOR REFERRING GOODS AND SERVICES VIA A SOCIAL MEDIA FEED

(71) Applicant: HRB TAX GROUP, INC., Kansas City, MO (US)

(72) Inventors: Jason Houseworth, Olathe, KS (US); Matthew Murphy, Arlington Heights, IL (US)

(73) Assignee: HRB Tax Group, Inc., Kansas City, MO (US)

(21) Appl. No.: 13/834,160

(22) Filed: Mar. 15, 2013

Related U.S. Application Data
(60) Provisional application No. 61/635,062, filed on Apr. 18, 2012.

(51) Int. Cl. G06Q 30/02; G06Q 50/00

(52) U.S. Cl. CPC G06Q 30/0214; G06Q 50/01
USPC 705/14.16

(57) ABSTRACT

A computer program, method, and system for referring goods and services via a social media feed. More particularly, the computer program, method, and system provide for a user to refer goods or services through a social media feed and to receive a benefit, such as a monetary amount or a coupon, for referring the goods or services. For instance, a user may request to electronically refer at least one good or service offered by a retailer. Upon receiving such a request, a unique referral link may be generated that is operable to direct third parties to an electronic resource hosted by the retailer. After the user embeds the unique referral link in the user's social media feed, then third parties may select the unique referral link, such that the third party is provided access to the electronic resource hosted by the retailer. Finally, a virtual credit may be provided to the electronic referral account of the user upon the third party selecting the unique referral link.

### RELATED APPLICATIONS

This non-provisional patent application claims priority benefit, with regard to all common subject matter, of earlier-filed U.S. Provisional Patent Application No. 61/635,062, filed Apr. 18, 2012, and entitled “METHOD, SYSTEM, AND COMPUTER PROGRAM FOR REFERRING GOODS AND SERVICES VIA A SOCIAL MEDIA FEED.” The identified earlier-filed provisional patent application is hereby incorporated by reference in its entirety into the present application.

### FIELD

Embodiments of the present invention provide a method, a system, and a computer program for referring goods and services via a social media feed. More particularly, embodiments of the present invention provide for a user to refer goods or services through a social media feed and to receive a benefit, such as a monetary amount or a coupon, for referring the goods or services.

### BACKGROUND

Social media has quickly become a significant aspect of most people's daily lives. Recent surveys indicate that over half of all people in the United States have at least one social media profile on a social networking service. A significant portion of those people with social media profiles will access the social networking service multiple times throughout a given day. The popularity and mainstream use of social networking services has provided an opportunity for new streams of marketing and advertising. For example, each Facebook™ member has on average one-hundred forty friends in their social network community. Thus, if such a Facebook™ member allowed a company to advertise on the member's Facebook™ profile, the company's advertisement would be able to reach, on average, an additional one-hundred forty people. However, although the popularity of social media has provided a potential avenue for advertising and marketing, such an avenue has not been fully realized because people with social media profiles have no incentive to allow companies to advertise or market via their social networks.

### SUMMARY

Embodiments of the present invention provide for a method, system, and computer program directed to referring goods and services. Embodiments include the initial step of providing a referral management resource for managing an electronic referral account of a user, with the electronic referral account functional to manage information indicative of referral activity associated with the user. In a next step, a request to electronically refer at least one good or service is received from the user. Upon receiving such a request, the next step includes generating a unique referral link operable to direct third parties to an electronic resource hosted by a retailer offering goods and services. In the next step, the user is provided with the unique referral link for embedding on the user's social media feed. Embodiments of the present invention then receive an indication of a third party selecting the unique referral link embedded on the user's social media feed, such that the third party is provided access to the electronic resource hosted by the retailer. Finally, a virtual credit is provided to the electronic referral account of the user upon receiving the indication of the third party selecting the unique referral link.

Embodiments of the present invention provide for a method, system, and computer program directed to referring goods and services. Embodiments additionally include the initial step of providing a referral management resource for managing an electronic referral account of a user, with the electronic referral account functional to manage information indicative of referral activity associated with the user. In a next step, a request to electronically refer at least one good or service is received from the user. Upon receiving such a request, the next step includes generating a unique referral link operable to direct third parties to an electronic resource hosted by a retailer offering goods and services. In the next step, the user is provided with the unique referral link for embedding on the user's social media feed. The next step includes receiving an indication of the user embedding the unique referral link on the user's social media feed. Upon receiving the indication of the user embedding the unique referral link on the user's social media feed, the next step includes providing a first virtual credit to the electronic referral account of the user. Embodiments of the present invention then receive an indication of the unique referral link being embedded on a social media feed of a third party. Upon receiving such an indication, an additional first virtual credit is provided to an electronic referral account of the third party and a second-tier virtual credit is provided to the electronic referral account of the user.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a flow chart of a method for referring goods and services according to embodiments of the present invention;

FIG. 2 is a schematic depiction of a system for referring goods and services in accordance with embodiments of the present invention;

FIG. 3 is a schematic depiction of a network for referring goods and services in accordance with embodiments of the present invention; and

FIG. 4 is a flow chart of an additional method for referring goods and services according to embodiments of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

The present invention provides various embodiments of a computer program, a method, and a system for referring goods and services. In more detail, embodiments of the present invention may be implemented to allow users to refer goods and services via the user's social media feeds and to further provide such users with a benefit for referring the goods and services. As used herein, social media feeds are generally defined to be communications platforms offered by social networking services. In general, social media feeds provide users with communications platforms to communicate with third parties who are included in the user's social network community within a given social networking service. Exemplary social networking services that provide users with social media feeds may include, for instance, Facebook™, Twitter™, Google+™, LinkedIn™, Pinterest™, tumbler™, Youtube™, and Instagram™. However, such social networking services are provided for illustrative purposes, and embodiments of the present invention includes referring goods and services on any social networking service that offers a social media feed. In additional embodiments, social media feeds may include communications platforms not offered by social network services, such as personal blogs, websites, emails, text messages, or the like. A social network community is generally referred to herein as a group of people, or more precisely representations or profiles of a group of people, who are each capable of viewing and/or accessing the user's social media feed for a given social networking service. Depending on the applicable social networking service, people may become part of a user's social network community by “friending,” “following,” or “joining” with the users social media profile.

Embodiments of the present invention thus provide for users to refer goods and services by advertising and marketing such goods and services to third parties comprising the user's social network community via the user's social media feed. In exchange for referring goods and services, embodiments of the present invention facilitate a benefit to be provided to the user. Embodiments further provide for multiple levels, tiers, or amounts of benefits to be provided to the user based on the referrals made by the user and further based on actions performed and purchases made by third parties of the user's social network community.

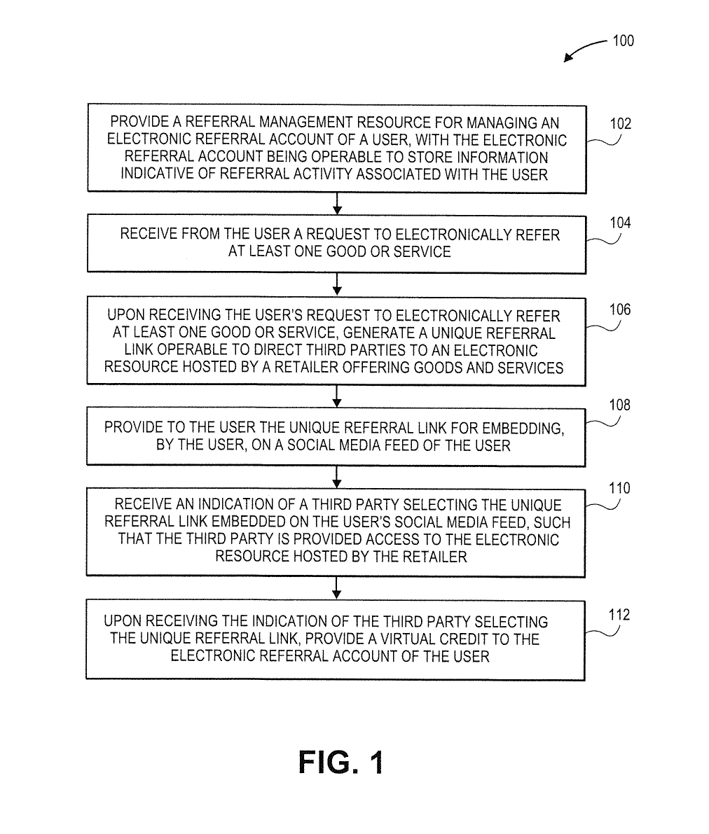

As illustrated in FIG. 1, embodiments of the present invention may include a method 100 with an initial Step 102 of providing a referral management resource for managing an electronic referral account of a user, with the electronic referral account functional to manage information indicative of referral activity associated with the user. In Step 104, a request to electronically refer at least one good or service is received from the user. Upon receiving such a request, the next Step 106 includes generating a unique referral link operable to direct third parties to an electronic resource hosted by a retailer offering goods and services. In the next Step 108, the user is provided with the unique referral link for embedding on the user's social media feed. In the next Step 110, embodiments of the present invention receive an indication of a third party selecting the unique referral link embedded on the user's social media feed, such that the third party is provided access to the electronic resource hosted by the retailer. Finally, the remaining Step 112 includes providing a virtual credit to the electronic referral account of the user upon receiving the indication of the third party selecting the unique referral link. Thus, embodiments of the present invention are directed to a method, system and computer program for referring goods and services. Specifically, embodiments of the present invention may be implemented to facilitate a user in providing a referral for a good or service on the user's social media feed, and further to provide a benefit to the user for providing the referral.

As a non-limiting example, a user may post an electronic referral link (e.g., a link, hyperlink, uniform resource locator (URL), etc.), via the user's Twitter™ feed, that references a good or service being offered by a retail website. Third parties who are part of the user's social network community and thus have access to the user's social media feed may view electronic referral link and select the link to learn more about the good or service. In embodiments of the present invention, the electronic referral link may be a hyperlink that is affiliated with a particular website hosted by a retailer offering goods and services. For example, if the user posts an electronic referral link to a pair of shoes that the user likes or otherwise would like to refer, selection of the hyperlink directs a third party to the affiliated website offering for sale the pair of shoes. Upon the third party selecting the hyperlink and accessing the website, the user may be provided with a benefit, such as a monetary amount, a coupon, a discount, or the like. In even further embodiments, should the third party subsequently purchase the pair of shoes from the website, the user may be credited with additional benefits.

The computer program of embodiments of the present invention comprises a plurality of code segments executable by a computing device for performing the steps of the method of the present invention. The steps of the method may be performed in the order shown in FIG. 1, or they may be performed in a different order. Furthermore, some steps may be performed concurrently as opposed to sequentially. Also, some steps may be optional.

### System Description

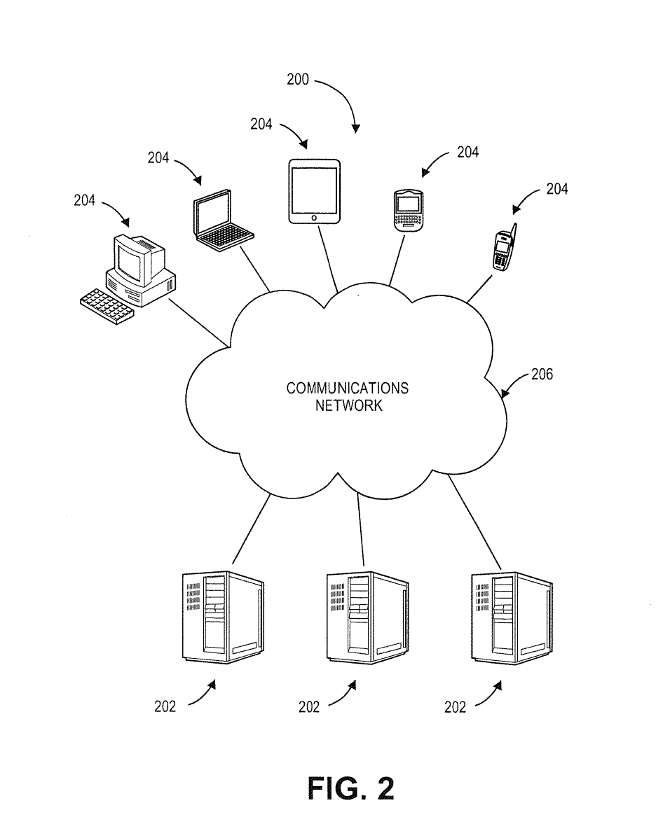

The computer program, system, and method of embodiments of the present invention may be implemented in hardware, software, firmware, or combinations thereof using the electronic referral management system 200, shown in FIG. 2, which broadly comprises server devices 202, computing devices 204, and a communications network 206. The server devices 202 may include computing devices that provide access to one or more general computing resources, such as Internet services, electronic mail services, data transfer services, and the like. The server devices 202 may also provide access to a database that stores information and data necessary for the implementation of the computer program, method, and embodiments of the present invention.

The server devices 202 and computing devices 204 may include any device, component, or equipment with a processing element and associated memory elements. The processing element may implement operating systems, and may be capable of executing the computer program, which is also generally known as instructions, commands, software code, executables, applications, apps, and the like. The processing element may include processors, microprocessors, microcontrollers, field programmable gate arrays, and the like, or combinations thereof. The memory elements may be capable of storing or retaining the computer program and may also store data, typically binary data, including text, databases, graphics, audio, video, combinations thereof, and the like. The memory elements may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, the server devices 202 may further include file stores, such as may be included in the associated database, comprising a plurality of hard disk drives, network attached storage, or a separate storage network. The functionality of server devices 202 may also be distributed amongst many different computers in a cloud computing environment.

At least one of the server devices 202 may operate and/or host a website or implement a mobile application accessible by at least some of the external computing devices 204. The server device 202 may include conventional web hosting operating software, an Internet connection, such as a cable connection, satellite connection, DSL converter, or ISDN converter, and is assigned a URL and corresponding domain name so that the website hosted thereon can be accessed via the Internet in a conventional manner. In embodiments of the invention where the server device 202 implements a mobile application (i.e., an “app”), the server device may host and support software and services of proprietary mobile application providers, such as Google, Apple, and Blackberry. For example, some server devices 202 may support Google Android mobile applications, while other server devices may support Apple iPhone mobile applications.

The computing devices 204 may include mobile communication devices (including wireless devices), work stations, desktop computers, laptop computers, palmtop computers, tablet computers, portable digital assistants, smart phones, and the like, or combinations thereof. In certain embodiments, the computing device 204 will have an electronic display, such as a cathode ray tube, liquid crystal display, plasma, or touch screen that is operable to display visual graphics, images, text, etc. In certain other embodiments, the computer program of the present invention facilitates interaction and communication through a graphical user interface (GUI) that is displayed via the electronic display. The GUI enables the user to interact with the electronic display by touching, pointing, or otherwise selecting display areas to provide information to the user control interface, discussed in more detail below.

The computing devices 204 may include a user control interface that enables one or more users to share information and commands with the computing devices or server devices 202. The user interface may comprise one or more functionable inputs such as buttons, keyboard, switches, scrolls wheels, voice recognition elements such as a microphone, pointing devices such as mice, touchpads, tracking balls, styluses. The user control interface may also include a speaker for providing audible instructions and feedback. Further, the user control interface may comprise wired or wireless data transfer elements, such as a communication component, removable memory, data transceivers, and/or transmitters, to enable the user and/or other computing devices to remotely interface with the computing devices 204.

The communications network 206 may be wired or wireless and may include servers, routers, switches, wireless receivers and transmitters, and the like, as well as electrically conductive cables or optical cables. The communications network 206 may also include local, metro, or wide area networks, as well as the Internet, or other cloud networks. Furthermore, the communications network 206 may include cellular or mobile phone networks, as well as landline phone networks, public switched telephone networks, fiber optic networks, or the like.

Both the server devices 202 and the computing devices 204 may be connected to the communications network 206. Server devices 202 may be able to communicate with other server devices 202 or computing devices 204 through the communications network 206. Likewise, computing devices 204 may be able to communicate with other computing devices 204 or server devices 202 through the communications network 206. The connection to the communications network 206 may be wired or wireless. Thus, the server devices 202 and the computing devices 204 may include the appropriate components to establish a wired or a wireless connection.

The computer program of the present invention may run on one or more server devices 202 or, alternatively, may run on computing devices. In additional embodiments, a first portion of the program, code, or instructions may execute on a first server device 202 or a first computing device 204, while a second portion of the program, code, or instructions may execute on a second server device 202 or a second computing device 204. In some embodiments, other portions of the program, code, or instructions may execute on other server devices 202 as well. For example, information may be stored on a memory element associated with the server device 202, with such information being remotely accessible to users of the computer program via one or more computing devices 204. Alternatively, information may be directly stored on the memory element associated with the one or more computing devices 204 of the user. In additional embodiments of the present invention, portions of information related may be stored on the server device 202, while other portions may be stored on the one or more computing devices 204. The various actions and calculations described herein as being performed by or using the computer program may actually be performed by one or more computers, processors, or other computational devices, such as the computing devices 204 and/or server devices 202, independently or cooperatively executing portions of the computer program.

In certain embodiments of the present invention, portions of the computer program may be embodied as a stand-alone program downloaded on a user's computing device 204 or in a web-accessible program that is accessible by the user's computing device 204 via the network 206, each of which being functional to access an electronic resource. For the stand-alone program, a downloadable version of the computer program may be stored, at least in part, on the server device 202. A user can download at least a portion of the computer program onto the computing device 204 via the network 206. In such embodiments of the present invention, the computer program may be an “application,” such as an “app” for a mobile device. After the computer program has been downloaded, the program can be installed on the computing device 204 in an executable format. The executable form of the program permits the user to access embodiments of the present invention via the electronic resource, such as a mobile “app” or website. For the web-accessible computer program, the user may simply access the computer program via the network 206 (e.g., the Internet) with the computing device 204.

Once the user has access to the electronic resource, via the computer program installed on a user's computing device 204 or the web, certain embodiments may provide for users to create accounts with which to access the electronic resource. The user accounts may be stored within the memory elements of the computing device 204, the server 206, or in the associated database. Embodiments of the present invention may broadly provide for an electronic referral account. However, other embodiments of the present invention may include any number and/or any specific types of account as may be necessary to carry out the functions, features, and/or implementations of the present invention.

The electronic referral account is an account created by or for users that intend using embodiments of the present invention to make electronic referrals to goods and services offered by retailers. The user may logon to the electronic referral account to access the electronic resource via a computing device 204. Each user with an electronic referral account may be required to enter, or have entered, various pieces of identification information, such as email address, name, home address, date of birth, telephone number or the like. In additional embodiments, the user may be required to provide profile names, and in certain embodiments, passwords for each of the social networking services that the user would like to have associated with the electronic referral account. As will be discussed in more detail below, certain embodiments of the present invention may provide for the user to be provided with benefits via various types of payment vehicles. Thus, embodiments of the present invention may require the user to provide certain financial institution information, such as bank name, bank account number, routing number, or the like. In embodiments where monetary amounts are transferred, the user may additionally be required to provide detailed identification information, such as a social security number, tax identification number, or the like. In addition, the user may be required to enter or will otherwise be provided with a username and password, which may be required for the user to login to the user's account and access the electronic resource. All information entered by the user is received, via the network 206, and may be stored on the computing device 204, the server device 202, or the associated database.

Although certain details and descriptions provided below discuss certain functions, features, and/or implementations of the present invention being carried out by a particular type of user or user account, it is hereby understood that such descriptions are simply provided for illustrative purposes. Thus, for example, certain functions described below as being performed by specific users and/or specific types of accounts may, in certain embodiments, be performed by other types of user and/or other types of accounts. Similarly, embodiments of the present invention may include other additional types of users and accounts, as may be necessary to implement embodiments of the present invention.

Further, although certain embodiments of the present invention may require a user to establish an electronic referral account to access the electronic resource, certain other embodiments may provide for certain features of the present invention to be utilized without requiring the establishment of an account. For instance, a potential user may access certain portions of the electronic resource to browse the electronic resource and to gain information about the benefits of obtaining an electronic referral account, without first being required to establish an electronic referral account.

### Operation

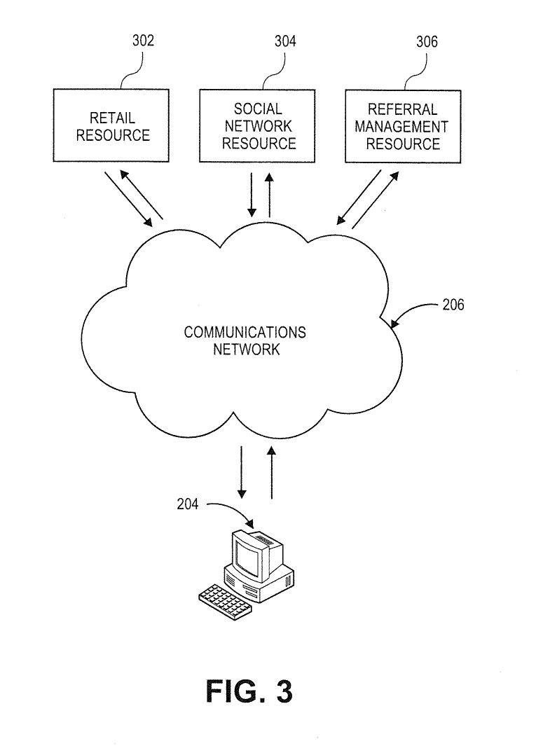

Embodiments of the present invention are directed to a method, system and computer program for referring goods and services. Specifically, embodiments of the present invention may be implemented to encourage users to refer goods and services using the users' social media feeds by providing such users with various forms of benefits. Embodiments of the present invention may be implemented through an electronic referral network 300, as illustrated in FIG. 3, that broadly includes an electronic resource hosted by a retailer, hereinafter referred to as retail resource 302, with the retailer being in the business of offering goods and services; an electronic resource hosted by a social networking service, hereinafter referred to as social network resource 304, with the social network service providing social media feeds for its users; the electronic resource implemented via the computer program of embodiments of the present invention, hereinafter referred to as referral management resource 306, with the referral management resource hosted by a referral management provider; the computing device 204 through which a user can access embodiments of the present invention, the retail resource, and the social network resource; and the communications network 206 for facilitating communications between each of the users and the resources. Thus embodiments of the present invention provide for a user to make an electronic referral of a good or service offered on the retail resource 302 by referring the good or service via the user's social media feed on the social network resource 304. In addition to facilitating the electronic referral, the referral management resource 306 functions to manage and track all referral activity corresponding to and/or resulting from the user's electronic referral, such that the user can be provided with benefits based on such referral activity.

Embodiments of the present invention contemplate affiliations or other business relationships between the referral management provider and a plurality of retailers, such as on-line retailers, e-commerce websites, or other retailers with an on-line presence and that offer goods and services. In certain embodiments, the referral management provider may itself be a retailer, such that the referral management provider hosts both the referral management resource 306 and the retail resource 302. In embodiments in which the referral management provider is not the retailer, if the retailer desires to participate in the electronic referral network 300 discussed herein, the retailer agrees to remunerate users of embodiment of the present invention with various benefits in exchange for the user's referral of the retailer's goods and services. In certain embodiments and as will be described in more detail below, an amount of the provided benefits may be dependent on various factors, such as attributes of the user or of the user's social network community, actions taken by third parties comprising the user's social network community in response to an electronic referral, purchases made by third parties in response to an electronic referral, or other factors. As an illustrative example, a retailer may agree to remunerate a user on a percentage of any sales resulting from an electronic referral made by the user. For instance, the retailer may pay a benefit in the amount of “X” percent of a purchase price for each purchase resulting from a user of the referral management resource making an electronic referral of a good or service that is later sold from the retailer's retail resource 302. Alternatively, instead of a percentage of the purchase price, the retailer may provide a coupon or a discount to the user. In further embodiments, the user may accrue virtual credits, which are managed and tracked by the referral management resource and that are representative of and exchangeable for other benefits.

As was previously described, the referral management resource 306 may be a hosted website, mobile application, or other electronic resource that is capable of monitoring and tracking referral activity and associated benefits that correspond to referrals made by the user. As will be described in more detail below, the benefit provided to a user from a retailer is dependent on the type of referral activity that was performed by the user and/or the type of referral activity that was performed by a third party in response to the user's referral. In particular, referral activity may broadly comprise: electronic referrals, which may include embedding and/or posting electronic referral links in the user's social media feed; actions, which may include a third party selecting, viewing, liking, or otherwise interacting with the electronic referral links embedded on the user's social media feed; and purchases, which may include purchases of goods and services from a retail resource 302 in response to the electronic referral link embedded in the user's social media feed. As discussed in more detail below, the referral management resource 306 may provide a dashboard, viewable on the computing device 204 of the user, for easily viewing the referral activities that resulted in benefits, the accumulated benefits acquired by the user, and/or other information pertinent to the user or a referral activity. Because accumulated benefits that have not yet been realized by the user are represented in the dashboard, such representations of benefits may be described herein as virtual credits.

Embodiments of the present invention correlate referral activity that is associated with the user via the user's electronic referral account so that the user may receive a benefit and/or virtual credit for each applicable referral activity. Without this correlation, the user may not receive the benefit or virtual credit that is owed to the user for the referral activity. Therefore, embodiments of the present invention provide various methods for associating referral activities with the user's electronic referral account. Beginning with electronic referrals, a retail resource 302 participating in the referral network 300 may include a selectable link at each webpage or screen of its website and/or mobile app, from which the retailer offers for sale a good or service. For example, consider a retail resource 302 that advertises and offers for sale a pair of shoes via a particular webpage or screen of the retail resource. Included within the webpage or screen may be a selectable link from which a user of the referral management resource 306 can select to indicate that the user would like to refer the pair of shoes. An exemplary selectable link is an icon or text-box displayed on the retail resource 302 site stating “Refer These Shoes to a Friend Via the Referral Management Resource.”

Upon the user selecting the selectable link, an electronic referral link is generated and provided to the user. As was previously described the electronic referral link may be a link, hyperlink, URL, or other web address information that when selected, directs third parties to the retail resource 302. Because it is necessary to correlate referral activity with the user performing the referral, certain embodiments of the preset invention provide for the electronic referral link to be uniquely generated, such that it includes information that associates the electronic referral link with the user. For instance, in addition to including web address information to direct a third party to the retail resource 302, the electronic referral link may also include information that associates the electronic referral link with the user. Such information may be a uniquely generated alphanumeric number, code, or the like. In additional embodiments, the uniquely generated electronic referral link may direct third parties to a unique webpage provided by the retail resource 302. For instance, if a third party selects the uniquely generated electronic referral link, the third party may be directed to a webpage that states “Hey Friend of User. Your Friend User Purchased These Shoes in Red. What's Your Size and Color?”

By associating the electronic referral link with the user, if a third party selects the electronic referral link and accesses the retail resource, such information is transmitted to the referral management source 306 for management and tracking of corresponding referral activity. Once the electronic referral link has been generated, the electronic referral link may be presented to the user via the retail resource 302 such as through the webpage or screen displayed on the electronic display of the user's computing device 204. The user may obtain the electronic referral link by copying the electronic referral link directly from the retail resource 302. Once the electronic referral link has been obtained, the user may make an electronic referral to the retail resource 302 by posting, pasting, embedding, attaching, or otherwise associating the electronic referral link with the user's social media feed. “Post” or “posting” as defined herein includes pasting, attaching, embedding, or otherwise associating the electronic referral link in any type of social media feed of the user.

In an alternative embodiment for providing the electronic referral link to the user, upon the user selecting the selectable link at the retail resource 302 (i.e., “Refer These Shoes to a Friend Via the Referral Management Resource”), a new screen, a new webpage, or a new window may open where the electronic referral link is displayed on the electronic display of the user's computing device 204. The user may then copy the electronic referral link and post the electronic referral link into the user's social media feed. Alternatively, upon the user selecting the selectable link on the retail resource 302, a separate screen or webpage may be displayed wherein the user may enter identifiers for one or more social network resources 304 to which the user would like the electronic referral link to be automatically posted to the user's social media feed. For example, the user may be required to enter the user's account name and password for their Twitter™ feed or the user's Facebook™ wall. Upon selecting one or more social network resources 304, embodiments of the present invention, through an application programming interface (API), automatically post the electronic referral link to the user's social media feed. As an even further alternative, the user may have a registered account with the retail resource 302, such that the retail resource has stored information regarding the user and the user's available social media feeds. As such, the user's selection of the selectable link on the retail source 302 may immediately and automatically posts the electronic referral link to one or more of the user's social media feeds, without the user being required to select the appropriate social network resource 304 or entering the user's account name and password. In any of the above distribution methods for the electronic referral link, in addition to simply posting the electronic referral link, the user may also be provided with the option to include additional information or commentary regarding the electronic referral link. For example, the user may provide a personal message along with the electronic referral link on the user's social media feed, such as “Look at these great shoes. [insert referral link]. What a bargain!”

Embodiments of the present invention do not require that the user actually purchase the good or services from the retail resource 302 before being able to post an electronic referral link referring the good or service via the user's social media feed. However, should the user purchase a good or service from the retail resource 302, another selectable link prompting the user to refer the good or service may be provided to the user while the user is “checking out” from the retail resource 302. For example, the retail resource 302 may include a selectable link, similar to the “Refer These Shoes to a Friend Via the Referral Management Resource” link described above, at the “checkout” webpage or screen provided by the retail resource for allowing the user to purchase the good or service. Selection of such a selectable link operates as previously described. Providing the selectable link at the checkout webpage or screen of the retail resource 302 provides an opportunity to remind the user to refer the good or service to third parties in the user's social network community. Additionally, if the user posts the electronic referral link after purchasing the good or service, the post may include supplemental information identifying that the user had actually purchased the referred good or service. For example, the user may provide a personal message along with the electronic referral link on the user's social media feed, such as “Look at these great shoes I just purchased at [insert referral link]!” In even further embodiments, the user may be prompted, after purchasing a good or service, to post an electronic referral link to the purchased good or service. Such prompts may be provided to the user by way of an electronic survey, an electronic receipt, or any other electronic communications sent from the retail source 302.

To obtain credit for posting the electronic referral link in the user's social media feed, the user's posting must be associated with the user's electronic referral account with the referral management resource 306. In certain embodiments, as was described above, the electronic referral link may be uniquely generated, such that each electronic referral link uniquely identifies the user making the referral. In additional embodiments of the present invention, the user may also be provided with the opportunity to enter the user's referral account information (e.g., username and password) or social media profile information (e.g., username, profile name, etc.) upon obtaining the electronic referral link, such that the retail resource 302 records the particular user obtaining and posting the electronic referral link. For example, if the user selects the selectable link on the webpage of the retail resource 302, the webpage may prompt the user to enter the user's electronic referral account information (e.g., username and password). Once the retail resource has associated the electronic referral link with the user's electronic referral account with the referral management resource 306, information identifying the user as having posted the electronic referral link may be transferred from the retail resource 302 to the referral management resource for management and tracking purposes. In even further embodiments, the referral management resource 306 may include an API that functions to interact with a retail resources 302 participating in the network 300, such that the user's actions within the retail resource (e.g., obtaining an electronic referral link, posting the electronic referral link, etc.) is automatically transferred to the referral management resource. In still even further embodiments, the referral management resource 306 may include an API that functions to interact with the social network resource 304 within which the user posted the electronic referral link. Upon the referral management resource obtaining information related to each of the electronic referrals posted by the user, the user's electronic referral account is credited with a virtual credit that corresponds to a benefit.

As will be discussed in more detail below, the virtual credits may be redeemed for benefits, including monetary benefits, coupons, discounts, or the like. The amount of the virtual credits, and thus the benefits, provided to the user for posting an electronic referral link may be dependent on multiple factors. For instance, such factors may include: the amount of virtual credits and/or benefits offered by the retail resource 302 for making an electronic referral, the number of electronic referral links posted by the user on a given social network resource 304, the number of social network resources to which the user posts an electronic referral link to their social media feed, the number of third parties in the user's social network community, or other factors as may be determined by the retail resource and/or referral management provider.

Upon the user posting the electronic referral link in the user's social media feed, third parties comprising the user's social network community may perform various actions associated with the electronic referral link. Such actions may be considered additional types of referral activities from which the user may receive virtual credits, and thus benefits, on their electronic referral account. Such actions may include, among other examples, selecting the electronic referral link, acknowledging the electronic referral link, or performing another action associated with the referral link. Selection of the electronic referral link is defined as selecting, clicking, or otherwise accepting the electronic referral link, such that the third party is directed to the retail resource 302 associated with the referred good or service. Acknowledging the electronic referral link may include any form of recognizing the electronic referral link, as may be appropriate for a given social media network. Such forms of recognition may include, for instance, the third party “liking,” “retweeting,” “sharing,” or commenting on the electronic referral link. Other actions associated with the electronic referral link may include viewing videos, listening to songs and/or advertisements, taking part in surveys, or interacting with other actionable items associated with the electronic referral link. Such other actions may be accessible to third parties along with the posted electronic referral link on the user's social media feed. For instance, as the user posts the electronic referral link related to a good or service offered by a retail resource 302, a video advertisement related to the good or service may additionally be posted within the user's social media feed. In even further embodiments, such a video may be included directly on a webpage of the retail resource 302, such that after the third party selects the electronic referral link and is directed to the retail resource, the third party has access to the video. If the third party views the video, or takes other action with respect to the electronic referral link, the user may be provided with an additional virtual credit and/or benefit.

As with posting the electronic referral link, to obtain credit for a third party performing actions associated with the referral link, information regarding the third party's actions must be associated with the user's electronic referral account with the referral management resource 306. In certain embodiments, as was previously described, the electronic referral link is uniquely generated, such that each electronic referral link and any actionable items associated with the electronic referral link (i.e., videos, songs, advertisements, surveys, etc.) are all uniquely associated with the user making the referral. Thus, if a third party selects the electronic referral link and is directed to the retail resource 302, the user that posted the electronic referral link receives a virtual credit and/or benefit. Similarly, if a third party acknowledges the electronic referral link and/or takes part in other actionable items (i.e., videos, songs, advertisements, surveys, etc.), the user that posted the electronic referral link receives a virtual credit and/or benefit. Thus, because the electronic referral link is uniquely associated with the user that posted it, embodiments of the present invention may track actions of third parties that interact with the electronic referral link or other actionable items associated with the electronic referral link. In additional embodiments of the present invention, the third party may also be provided with the opportunity to enter information associated with the user that referred the third party to take actions with respect to the electronic referral link. Such information may include the user's referral management account information (e.g., username and password), or it may alternatively include the user's social media profile information (e.g., username, profile name, etc.) for an applicable social network service. For example, if the third party selects the electronic referral link and is provided access to the retail resource 302, the third party may be asked to provide identifying information as to the user that referred the third party to the retail resource. Regardless of how the retail source 302 identifies the user, once the retail resource 302 has associated the third party's actions with the user's electronic referral account with the referral management resource 306, such information may be transferred from the retail resource 302 to the referral management resource for management and tracking purposes. In even further embodiments, the referral management resource 306 may include an API that functions to interact with retail resources 302 participating in the network 300, such that the third party's actions within a retail resource (e.g., accessing the retail resource, watching videos, listening to songs/advertisements, taking part in surveys, etc.) is automatically transferred to the referral management resource for management and tracking. In still even further embodiments, the referral management resource 306 may include an API that functions to interact with the social network resources 304 within which the user posted the electronic referral link, such that if third parties acknowledge the electronic referral link (i.e., “liking,” “re-tweeting,” commenting on, etc.) or take other actions with respect to the electronic referral link, such information is automatically provided to the referral management resource. Upon the referral management resource obtaining information related to each action of the third party with respect to the electronic referral link posted by the user, the user's electronic referral account is credited with a virtual credit and thus a corresponding benefit.

A further type of referral activity from which the user may receive a benefit is a third party purchasing goods and services from the retail resource 302. Should the third party select the electronic referral link and subsequently purchase the good or service, the user receives an additional virtual credit and/or benefit. In embodiments of the present invention, the user receives credit for any subsequent purchase of the good or service by the third party. An amount of a benefit provided to the user upon a third party purchasing a good or service may be a percentage of the purchase price of the purchased good or service. In other embodiments, the amount of the benefit may be a fixed amount. As with other referral activities, to receive credit for a third party's purchase, information regarding the third party's purchase must be associated with the user's electronic referral account with the referral management resource 306. In certain embodiments, as was previously described, the electronic referral link is uniquely generated, such that when a third party selects the link and access the retail resource 302, the electronic referral link indicates to the retail resources that the third party was referred by the electronic referral link posted by the user. Thus, if a third party selects the electronic referral link and is directed to the retail resource 302, the user that posted the electronic referral link receives a benefit and/or virtual credit. Further, the user receives a credit regardless of whether the third party immediately purchases the good or service upon selecting the electronic referral link and accessing the retail resource 302. For instance, if the third party views the good or service, exits out of the retail resource 302 displaying the good or service, and then returns at a subsequent time, the user will still receive a virtual credit for the third party's purchase. An Internet browser operating on the third party's electronic computing device (e.g., computer, mobile wireless communications device, tablet, etc.) commonly caches previously accessed electronic resources. As part of such a caching process, when the third party accesses the retail resource 302 after selecting the electronic referral link, the information associated with the electronic referral link, including unique identification information of the user, is stored or otherwise associated with the cached electronic resource. Therefore, should the third party subsequently access the retail resource 302 via the third party's electronic computing device, the retail resource will receive information associating the particular cached retail resource with the referring user. In alternative embodiments, the third party may also be provided with the opportunity to enter information associated with the user, which identifies the user as having referred the third party to make a purchase of the good or service. Such information may include the user's referral management account information (e.g., username and password), or it may alternatively include the user's social media profile information (e.g., username, profile name, etc.) for an applicable social network service. For example, if the third party selects the electronic referral link and is provided access to the retail resource 302, the third party may be asked to provide identifying information as to the user that referred the third party to the retail resource. Regardless of how the retail source 302 identifies the user, once the retail resource 302 has associated the third party's actions with the user's electronic referral account with the referral management resource 306, such information may be transferred from the retail resource 302 to the referral management resource for management and tracking purposes.

As noted above, the user referring the goods and services via the user's social media feed receives a virtual credit and/or benefit for each referral activity (e.g., electronic referral, activity, purchase) associated with a retail resource 302 and/or a good or service. As was also previously described, the virtual credits tracked and presented on the dashboard of the referral management resource 306 are indicative of the actual benefits that may be received by the user. In certain embodiments, the virtual credits are tracked in real-time, such that as soon as a user is given credit for a referral activity, the user may be presented with the virtual credit nearly instantaneously on the user's dashboard. The benefits may include various types of benefits, such as a monetary benefit, coupons or discounts for future purchases, points or other “credits” for use to purchase goods or services, etc. Thus, the user receives benefits for referral activities, including as previously described, electronic referrals made by the user and also for activities and/or purchases made by third parties who are included in the user's social network community who performed activities and/or made purchased as a result of the user's posting of the electronic referral link in the user's social media feed. In certain embodiments an amount of the benefit may be dependent on the type of referral activity corresponding to the benefit. For instance, an amount of a monetary benefit received by a user for posting an electronic referral link may be less than an amount received for a third party performing an action or making a purchase associated with the electronic referral activity. Such a disparity in amounts may be a result of the distinction in realized values by the retail provider for the different types of referral activities. For example, the retail provider my find that a single purchase provides a larger return than a single action (i.e., watching a video, taking a survey, etc.), but a single action may provide a larger return than a single posting of an electronic referral link. However, in certain instances, a single posting of an electronic referral link may provide a larger benefit than a single action. For example, as previously described, the benefit amount for posting an electronic referral link may be based on a number of third parties included in the posting user's social network community. Thus, if a user has a very large number of third parties in the user's social network community, then a single posting of an electronic referral link may result in a higher benefit amount than another benefit associated with a single action.

In even further embodiments of the present invention and as discussed below, if a third party who received the user's electronic referral link reposts or otherwise forwards the electronic referral link to a social media feed of the third party's social network community, then both the user and the third party who reposted the original electronic referral link may receive a benefit. In such an embodiment, the third party must also have an electronic referral account with the referral management resource 306. Because the third party is reposting the electronic referral link, the electronic referral link is capable of being viewed by “second tier third parties” (i.e., third parties one step removed from the user who originally posted the electronic referral link). Should any second tier third party take an action with respect to the electronic referral link or make a purchase of the good or service after selecting of the reposted electronic referral link, then the third party (i.e., the re-“poster” of the electronic referral link) and the user (i.e., the original “poster” of the electronic referral link) both receive a virtual credit and/or benefit. Similarly, the user and applicable third parties would receive credit for any third, fourth, or subsequent tier third parties who re-post, take actions, or make purchases as a result of user original posting the electronic referral link.

In certain embodiments of the present invention, an apportionment of the benefit among the user and any subsequent tiered third parties may be required. For example, if a retail provider agrees to provide a benefit in an amount of “X” to the user that originally posted the electronic referral link, then the retail provider may also agree to give a benefit in the amount of “X” for any re-posts by any subsequent tiered third parties. However, the apportionment of the amount “X” for re-posted electronic referral links may require that the subsequent tiered third party (i.e., the re-“poster” of the electronic referral link) receives less than the full amount of “X.” For example, a third party that re-posts an electronic referral link that was originally posted by a user may receive 90 percent of “X.” The remaining benefit (i.e., 10 percent of “X”) may be credited to the user. As should be clear, an amount of a benefit received by the user for a re-posted electronic referral link by a third party may generally be less than an amount received for the initial posting of said electronic referral link by the user. However, the amounts of benefits may be apportioned as appropriate by the retail provider. Thus, embodiments of the present invention contemplate the use of multi-tiered virtual credits and/or benefits depending on the number or levels of users and/or third parties that take part in referral activities.

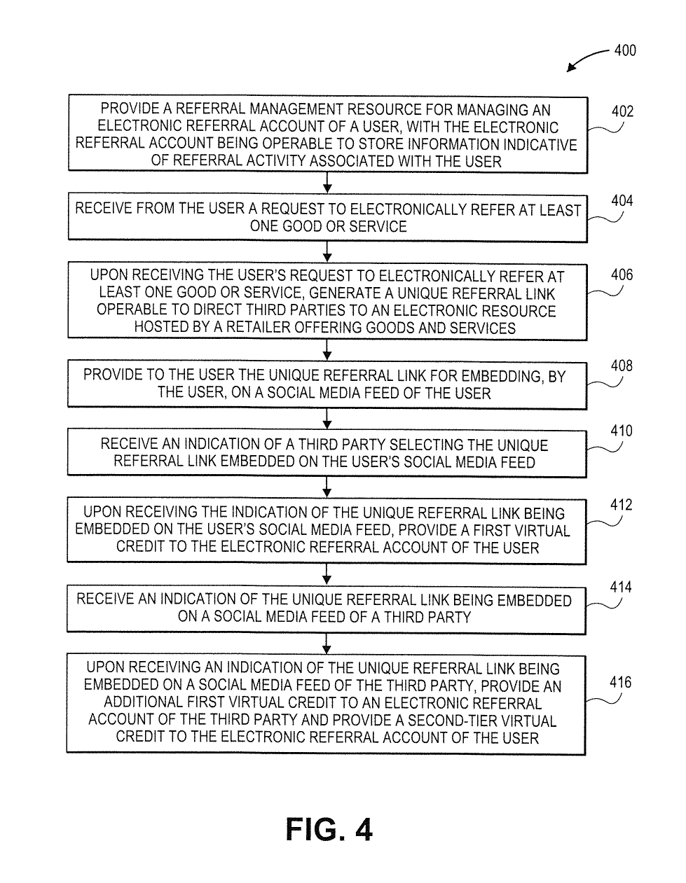

Thus, as illustrated in FIG. 4, embodiments of the present invention may include a method 400 with an initial Step 402 of providing a referral management resource for managing an electronic referral account of a user, with the electronic referral account functional to manage information indicative of referral activity associated with the users. In Step 404, a request to electronically refer at least one good or service is received from the user. Upon receiving such a request, the next Step 406 includes generating a unique referral link operable to direct third parties to an electronic resource hosted by a retailer offering goods and services. In the next Step 408, the user is provided with the unique referral link for embedding on the user's social media feed. In the next Step 410, embodiments of the present invention receive an indication of a third party selecting the unique referral link embedded on the user's social media feed, such that the third party is provided access to the electronic resource hosted by the retailer. In Step 412, upon receiving the indication of the unique referral link being embedded on the user's social media feed, embodiments provide a first virtual credit to the electronic referral account of the user. In Step 414, embodiments of the present invention include receiving an indication of the unique referral link being embedded on a social media feed of a third party. Finally, in Step 416, upon receiving an indication of the unique referral link being embedded on the social media feed of the third party, providing an additional first virtual credit to an electronic referral account of the third party and provide a second-tier virtual credit to the electronic referral account of the user. Thus, embodiments of the present invention include a method, system and computer program for providing multi-tiered referrals of goods and services. Specifically, embodiments of the present invention may be implemented to remunerate multiple levels of users and third parties for referring goods and services using their respective social media feeds.

As briefly described above, embodiments of the present invention provide a dashboard from which any user can view information regarding the user's electronic referral account. The dashboard may be electronically accessible via the referral management resource 306, which the user may access by logging into the user's electronic referral account. The dashboard accumulates information regarding the virtual credits and thus benefits owed to the user as a result of referral activities. The user may select to have the virtual benefits converted to actual benefits and provided to the user via the dashboard. As previously described, the benefits may include monetary benefits, coupons, discount points, or the like. In the case of monetary benefits, the user may select to receive the monetary benefits in the form of various payment vehicles, such as checks, prepaid cards, gift cards, or electronic funds transfers. The user may also link to a financial account, such as a bank account, credit card account, PayPal™ account, Google Wallet™ account, etc., such that monetary benefits can be credited directly to the user's financial account, either automatically or upon selection by the user. In the case of electronic funds transfers, the user may be required, as was previously described, to provide additional identification and banking information to the referral management resource 306. In certain embodiments, the monetary benefits may be provided directly from the retail provider, such that the referral management resource 306 may be required to instruct the retail provider when, how, and where to provide the benefit to the user. However, in other embodiments, the retail management resource 306 may act as an intermediary by immediately providing the user with the monetary benefit, and subsequently recouping the monetary benefit from the retail provider.

In addition to monetary amounts, the user may be provided with coupons and discounts. Such coupons and discounts may be provided directly by the retail provider and may be reimbursable for reduced pricing on selected goods and services offered by the retail resource 302 or for goods and services offered by other entities. The coupons and discounts may be in the form of physical benefits, such as paper coupons, which can be physically mailed to the user. However, in other embodiments, the coupons and discounts may be virtual coupons and discounts that may be provided to the user via electronic means, such as email, the user's social network resource 304, or the user's referral management resource 306.

Although this invention has been described with its preferred embodiment(s), it is noted that equivalents may be employed and substitutions made herein without departing from the scope of the invention.

Having thus described various embodiments of the invention, what is claimed as new and desired to be protected by Letters Patent includes the following:

1. A non-transitory computer readable storage medium with an executable program stored thereon for referring goods and services, wherein the program instructs a processor to perform the following steps:
provide a referral management resource for managing an electronic referral account of a user,
wherein the electronic referral account stores information indicative of referral activity associated with the user;
receive from the user a request to electronically refer at least one good or service;
upon receiving the user's request to electronically refer at least one good or service, generate a unique referral link operable to direct third parties to an electronic resource hosted by a retailer offering goods and services;
provide to the user the unique referral link for embedding, by the user, on a social media feed of the user;
receive an indication of a third party selecting the unique referral link embedded on the user's social media feed, such that the third party is provided access to the electronic resource hosted by the retailer; and
upon receiving the indication of the third party selecting the unique referral link, provide a virtual credit to the electronic referral account of the user.

2. The computer readable storage medium of claim 1, wherein the computer program further instructs the processor to perform the following steps:
wherein the virtual credit received upon the third party selecting the unique referral link is a second virtual credit,
receive an indication of the unique referral link being embedded on the user's social media feed; and
upon receiving the indication of the unique referral link being embedded on the user's social media feed, provide a first virtual credit to the electronic referral account of the user.

3. The computer readable storage medium of claim 2, wherein an amount of the first virtual credit is dependent on a number of third parties having access to the user's social media feed.

4. The computer readable storage medium of claim 2, wherein the computer program further instructs the processor to perform the following steps:
wherein the unique referral link includes information indicative of the user's electronic referral account managed by the referral management service,
upon receiving an indication of the third party making a purchase from the electronic resource hosted by the retailer, provide a third virtual credit to the electronic referral account of the user.

5. The computer readable storage medium of claim 4, wherein an amount of the third virtual credit is dependent on a price of the purchase made by the third party.

6. The computer readable storage medium of claim 4, wherein an amount of the third virtual credit is greater than the second virtual credit, and further wherein an amount of the second virtual credit is greater than the first virtual credit.

7. The computer readable storage medium of claim 1, wherein the computer program further instructs the processor to perform the following steps:
receive an indication of the unique referral link being embedded on a social media feed of the third party; and
upon receiving an indication of the unique referral link being embedded on a social media feed of the third party, provide an additional first virtual credit to an electronic referral account of the third-party and provide a second-tier virtual credit to the electronic referral account of the user.

8. The computer readable storage medium of claim 1, wherein the virtual credit is redeemable for a payment vehicle selected from one or more of the following: a coupon, an electronic funds transfer, a prepaid card, and a check.

9. A method for referring goods and services, including the following steps:
providing a referral management resource for managing an electronic referral account of a user,
with the electronic referral account functional to manage information indicative of referral activity associated with the user;
receiving from the user a request to electronically refer at least one good or service;
upon receiving the user's request to electronically refer at least one good or service, generating a unique referral link operable to direct third parties to an electronic resource hosted by a retailer offering goods and services;
providing to the user the unique referral link for embedding, by the user, on a social media feed of the user;
receiving an indication of a third party selecting the unique referral link embedded on the user's social media feed, such that the third party is provided access to the electronic resource hosted by the retailer; and
upon receiving the indication of the third party selecting the unique referral link, providing a virtual credit to the electronic referral account of the user.

10. The method of claim 9, further including the following steps:
wherein the virtual credit received upon the third party selecting the unique referral link is a second virtual credit,
receiving an indication of the unique referral link being embedded on the user's social media feed; and
upon receiving the indication of the unique referral link being embedded on the user's social media feed, providing a first virtual credit to the electronic referral account of the user.

11. The method of claim 10, wherein an amount of the first virtual credit is dependent on a number of third parties having access to the user's social media feed.

12. The method of claim 10, further including the following steps:
wherein the unique referral link includes information indicative of the user's electronic referral account managed by the referral management service,
upon receiving an indication of the third party making a purchase from the electronic resource hosted by the retailer, providing a third virtual credit to the electronic referral account of the user.

13. The method of claim 12, wherein an amount of the third virtual credit is dependent on a price of the purchase made by the third party.

14. The method of claim 12, wherein an amount of the third virtual credit is greater than the second virtual credit, and further wherein an amount of the second virtual credit is greater than the first virtual credit.

15. The method of claim 9, further including the following steps:
receiving an indication of the unique referral link being embedded on a social media feed of the third party; and
upon receiving an indication of the unique referral link being embedded on a social media feed of the third party, providing an additional first virtual credit to an electronic referral account of the third-party and provide a second-tier virtual credit to the electronic referral account of the user.

16. The method of claim 9, wherein the virtual credit is redeemable for a payment vehicle selected from one or more of the following: a coupon, an electronic funds transfer, a prepaid card, and a check.

17. A non-transitory computer readable storage medium with an executable program stored thereon for referring goods and services, wherein the program instructs a processor to perform the following steps:
provide a referral management resource for managing an electronic referral account of a user,
wherein the electronic referral account stores information indicative of referral activity associated with the user;
receive from the user a request to electronically refer at least one good or service;
upon receiving the user's request to electronically refer at least one good or service, generate a unique referral link operable to direct third parties to an electronic resource hosted by a retailer offering goods and services;
provide to the user the unique referral link for embedding, by the user, on a social media feed of the user;
receive an indication of the unique referral link being embedded on the user's social media feed;
upon receiving the indication of the unique referral link being embedded on the user's social media feed, provide a first virtual credit to the electronic referral account of the user;
receive an indication of the unique referral link being embedded on a social media feed of a third party; and
upon receiving an indication of the unique referral link being embedded on the social media feed of the third party, provide an additional first virtual credit to an electronic referral account of the third party and provide a second-tier virtual credit to the electronic referral account of the user.

18. The computer readable storage medium of claim 17, wherein the first virtual credit is greater than the second-tier virtual credit.

19. The computer readable storage medium of claim 17, wherein the computer program further instructs the processor to perform the following steps:
wherein the third party whose social media feed was embedded with the unique referral link is a primary third party;
receive an indication of a secondary third party selecting the unique referral link embedded on the user's social media feed, such that the secondary third party is provided access to the electronic resource hosted by the retailer; and
upon receiving the indication of the secondary third party selecting the unique referral link, provide a second virtual credit to the electronic referral account of the user.

20. The computer readable storage medium of claim 19, wherein the computer program further instructs the processor to perform the following steps:
wherein the unique referral link includes information indicative of the user's electronic referral account managed by the referral management service,
upon receiving an indication of the secondary third party making a purchase of from the electronic resource hosted by the retailer, provide a third virtual credit to the electronic referral account of the user.
